(19) United States
(12) Patent Application Publication
(10) Pub. No.: US 2012/0158414 A1
(43) Pub. Date: Jun. 21, 2012

(54) Collaborative Unemployment Management System and Method for Preserving the Economic, Professional and Personal Stability of Unemployed Workers and for Tracking their Outcomes

(76) Inventor: Wendell Watford, Pomonan, NY (US)

(21) Appl. No.: 12/969,796

(22) Filed: Dec. 16, 2010

(51) Int. Cl. G06Q 10/00

(52) U.S. Cl. 705/1.1

(57) ABSTRACT

A system and method for preserving the professional, economic and personal stability of workers who become unemployed and for tracking their outcomes through periods of employment/unemployment and beyond. The system makes use of an Affinity Service Organization™ (ASO™), which creates a permanent infrastructure and serves as a clearinghouse for managing the stability of workers. The ASO™ will allow for the delivery of economic stability, career management, job training/re-training and re-employment services to unemployed workers. In addition, it provides an electronic platform for the exchange of services, payment of fees associated with certain services and collection and recording of appropriate income withholding, FICA, FUTA, and SUTA taxes for its working members. The system is particularly useful in reducing unemployment by providing workers a wider range of employment options and for generating new tax revenues for local, state and federal taxing authorities.

### BACKGROUND OF THE INVENTION

1. Field of the Invention

This invention relates generally to a system that provides a perpetual infrastructure™ and a process for managing the way workers transition from a state of employment to unemployment and back to employment. The system involves the creation of an organizational framework (infrastructure) and a process for preserving the economic, professional and personal integrity of workers who become unemployed, for enhancing their rapid re-employment and for tracking their long-term outcomes. More specifically the system details methods for delivering: (1) career assessment/development/guidance services (CADG), (2) job training/re-training referral (JTR) services, (3) strategies for prolonging the economic stability (ES) of workers who become unemployed, (4) incentives for recruiters, employers and the government to work collaboratively toward the common goal of re-employment (ER) of unemployed workers as rapidly as possible with as little disruption in lifestyle as possible. The system has an inherent capability to generate new tax revenues for taxing authorities and to maintain connectivity with unemployed workers and track their long-term outcome (TLO) through periods of employment/unemployment and beyond.

For purposes of this application, the following definitions apply. These terms are used for illustrative purposes and should not be used to limit the scope of the invention:
ASO™—Affinity Services Organization (the organizational infrastructure that permits the delivery of group benefits and services to unemployed workers and independent contractors).
CADG—Career Assessment/Development/Guidance services is the career management module of the ASO™.
UNIVERSAL EMPLOYMENY™—A new employment concept that permits workers to be gainfully employed in non-traditional work arrangements with the same protection, privileges and responsibilities of traditional employees.
ES—Economic Stability module is a group of strategies for sustaining the income and lifestyle of unemployed workers at a level comparable to pre-unemployment levels through the innovative application and use of an FDIC Severance Fund to extend continuation of salary and groups benefits to unemployed workers for the duration of their severance awards.
ER—Enhanced Re-employment module is a group of proactive, innovative services delivered to unemployed workers to increase their re-entry to the workforce.
JTR—Job Training/Re-training Referral is the service module for the providing comprehensive access to job training/re-training for unemployed workers who require new or updated job skills to remain competitive.
TLO—Track Long-term Outcome is the service module for capturing and maintaining longitudinal work history, education, certifications and job skills data of all ASO™ members.
CMS—Career Management Services is the full range of ASO™ services offered to its members, which include CADG, ES, ER, JTR and TLO modules.
FDIC Severance Fund—A fund established and maintained by an independent third-party for the voluntary deposit of severance awards of unemployed workers to extend their period salary and group benefits continuation by making draw-downs for the duration of the severance award, thereby reducing dependence on state and federal SUIs. For the purpose of this invention, exhaustion of severance awards is required before unemployed workers with severance awards are eligible to collect unemployment benefits.
UE—Universal Employee™ (an unemployed worker or independent contractor who is a member of the ASO™ who agrees to accept contract work assignments through the ASO™ and thereby agree to have income and Social Security taxes and other authorized payroll deductions withheld from contract earnings).
CO—Companies (employers).
CE—Contract Employer is an employer who enters in agreement with the ASO™ to engage universal employees™ in contract placement opportunities and agree to bear the responsibility for payment of the employer's portion of FICA, FUTA, SUTA and to provide certification of WC coverage for universal employees™ employed on a contract basis.
CP—Contract Placement is a qualifying contract placement between a universal employee™ and a Contract Employer.
CBR—Contract Billable Rate is the agreed upon bill rate negotiated between a Contract

Employer and an authorized Placement Agent Subscriber or an Authorized Company Subscriber, which shall include the pay rate for the universal employee™, the employer's portion of FICA, FUTA, SUTA and the placement fee margin.
ACS—Authorized Company Subscriber is a current or most recent employer of an unemployed worker that has met the certification requirements to deliver the required ASO™ service modules to employees targeted for separation or who have recently separated from employer.
AGA—Authorized Government Agency Subscriber is any federal, state of local governmental agency or taxing authority that applies for and gains authorization to access secure areas of the ASO's database for withdrawing taxes or for uploading or updating government sponsored resource information relevant to sustaining the economic and professional stability of workers.
GA—Governmental Agency.
IC—Independent Contractor (a self-employed taxpayer that controls his or her own employment circumstances, including when and how work is done and must pay their own Social Security tax).
FICA—Social Security Tax.
FUTA—Federal Unemployment Tax
SUTA—State Unemployment Tax.
WC—Workers Compensation.
PA—Placement Agent (recruiter).
PAS—Placement Agent Subscriber is a professional recruiter or recruiting agency that has met the certification requirements to deliver the required ASO™ service modules to unemployed workers.
PERPETUAL INFRASTRUCTURE™—Is the creation of a permanent employment infrastructure that simulates the traditional employment infrastructure and extends beyond the traditional employment relationship. It allows for uninterrupted delivery of the same rights, protections and benefits to workers in non-traditional work arrangements as those afforded traditional employees in traditional employment relationships.
UW—Unemployed Worker.
USD—User Specific Dashboard (stakeholder-defined portal access to ASO™ database).

2. Description of the Related Art

Since the late 1980s companies, have overwhelmingly chosen mass layoffs during economic downturns as the accepted means of controlling labor overhead costs with the hope of mitigating business losses and erosion of profits. Unfortunately, mass layoffs have failed to produce the financial and operational results companies had hoped to realize. Instead, they have produced sharp increases in unemployment, which simultaneously resulted in millions of workers and their families losing income, and healthcare benefits. Income and healthcare benefits are the two foundational elements essential for providing economic, professional and personal stability for self and family; currently they both are inextricably tied to the maintenance of a group relationship commonly known as the employee/employer relationship. When the employee/employer relationship is severed, unemployed workers experience drastic economic, professional and personal lifestyle changes due to the loss of the group affiliation and therefore the employer-sponsored services and benefits that come with belonging to their employer group. Naturally, we expect that when the employee/employer relationship is severed, there will be a resultant loss of salary. However, there is no reason that the benefits derived from belonging to a “group,” in which volume is leveraged for the overall benefit of the individuals that make up the group, should end with termination of the employee/employer relationship. When this occurs, the unemployed worker suddenly finds him/herself catapulted into a solitary state without the security and benefits of the group relationship that was essential to the maintenance of economic, professional and personal integrity. It is therefore of critical importance that infrastructure be established that allows for the delivery of services and benefits to unemployed and other solitary workers comparable to those that employees receive from employers. Currently, no infrastructure exists outside of the realm of employer-based organizations for leveraging economy of scale (volume) to deliver group services and benefits to solitary workers. The present invention will create an organizational infrastructure that extends the benefits of economy of scale beyond the boundaries of the employer's workplace in order to preserve the integrity of workers' economic, professional and personal lifestyles.

When Unemployment Insurance (UI) legislation was passed back in the 1930s, its main purpose and intent were to provide a safety net for workers in the likelihood of unemployment. While the unemployment insurance program may have been structured to provide adequate subsistence for unemployed workers during the early- to mid-lifecycle of our industrial economy, it is unrealistic to expect it to adequately serve as a safety net for today's workers. The growth of salaries and the evolution of our industrial economy make it necessary to find new ways to meet the needs of today's workers who become unemployed. Moreover, it is unrealistic to assume that employers who are already over-extended with bearing the lion share of fixed employee overhead costs will be able to shoulder further increases to this already costly overhead expense category. When the average worker becomes unemployed today, the disparity between previous salary and unemployment benefits is staggering and can hardly be considered subsistence by today's standards. Depending on the state in which an unemployed worker lives, the maximum payable weekly UI benefit ranges from $230 to $628; this places the recipient at or below the poverty level by realistic U.S. standards. In addition, many states have already exhausted their SUI (State Unemployment Insurance) fund. This reality coupled with the growing disparity between payable UI benefits and the average worker's salary make it very clear that unemployment insurance alone is incapable of serving as the safety net for which it was originally intended. Therefore, in order to prevent such a drastic decline in the economic stability of workers who become unemployed, there must be willingness to explore new and more innovative ways of providing safety nets that are more realistic for today's unemployed workers. Although it requires legislative change, a strategy worth considering is a pre-tax severance fund to supplement UI. A pre-tax severance fund could also be used to create a safety net for “universal employees™” and independent contractors to sustain them during interim periods of unemployment. Heretofore, independent contractors have not had any form of safety net protection against periods of unemployment.

As the U.S. industrial economy has evolved over the last 70 years, we have witnessed the emergence and proliferation of a class of workers referred to as “independent contractors” for which no legislative provisions exist in the realm of Employee Welfare legislation that was enacted during 1930s because they didn't exist at least no to any significant degree. Currently, an estimated 15 million plus independent contractors represent an untapped resource that could very well hold the key to reversing our current job crisis and begin the road to economic recovery. Independent contractors play a vital role in today's labor economy, especially in certain cyclical or seasonal industries and they have the potential to play an even greater role in a broader spectrum of industries. The degree to which these industries will thrive depends on their ability to freely access and utilize the specialized talents and skills of this valuable talent pool. Unfortunately, a nationwide debate is taking place in various states and in our nation's capital generally known as “Misclassification of Independent Contractors”. The objective of these misguided debates and the resultant legislation is supposedly to ‘eliminate fraud’ on the part of the companies that use independent contractors. The legislation intends to force companies to hire “independent contractors” as “employees” as the way to control the “fraud”. The force driving these debates is an uncertainty on the part of the government as to how to ensure that independent contractors pay their fair share of local, state and federal taxes. The real problem with companies' use of independent contractors boils down to this one concern—the government does not have a consistent, reliable way to ensure that they will be able to collect the taxes owed by independent contractors. Therefore, they attempt to address this problem by passing legislation to force companies to hire independent contractors, which is restrictive and runs contrary to the economic plight of corporations. The effect of these various legislations will further cripple our already struggling economy by discouraging companies from hiring independent contractors in gainful contract employment. In addition, they further marginalize and disenfranchise independent contractors by failing to provide them with a legislative environment that includes their legal rights to work and receive the same equal protection as the traditional employee. State and federal legislators pushing these various legislations seem to be unaware of two very important facts about today's labor market. First, independent contractors have become a necessary part of the U.S. labor economy and, if given the same protection and rights as traditional employees, will become a significant source of tax revenues for local, state and federal taxing authorities. Continued failure to include independent contractors as an essential and legitimate part of our labor economy only deprives them and the companies that need their talent of productive work opportunities, which ultimately weakens the economy. Secondly, the nature of certain businesses and our economic climate are well suited to the use of independent contractors. Businesses will thrive and drive the economy if they are given the legal framework to utilize independent contractors freely and legally. At a critical time as this when policymakers should be exploring legislative solutions that encourage companies to hire and seeking new ways to expand coverage and extend employee rights and equal protection to all workers, they are creating and passing legislation that is contrary to protection of workers, job growth and economic stimulation.

Most organizations including our government will quickly claim commitment to the mantra, “people (employees) are our most important (greatest) asset”. If this were true, there would be tangible evidence of a universal commitment to maintaining this asset (people) in optimal operating condition as with the management of any other tangible asset through a process of continual investment. On-going asset maintenance is a basic underlying principle of any good asset management program. However, it is very difficult to find any evidence of a universal commitment to maintaining people's jobs skills in optimum working level, especially once they become unemployed. While individual employers may invest in the continual development of their active employees' jobs skills, once they cross over into unemployment, there is no universal system in place that allows for their on-going maintenance and professional development. Although there is a myriad of professional development and job training/re-training resources available through governmental and private sources, no centralized system exists for delivering these resources to those who need them most—the unemployed. In addition, the typical unemployed worker lacks the knowledge and expertise to access the widely dispersed resources that will enable them continue their professional development to keep their marketable skills current during periods of unemployment. Recruitment professionals, most of whom are experts at staying abreast of market trends and job skills that drive selected industries and/or career disciplines are not useful in helping unemployed workers maintain their jobs skills in optimal condition; this due largely to the fact that recruiters have not traditionally viewed themselves as agents or career coaches. Here lies a groundbreaking opportunity for the professional recruiter to expand his role and fill a necessary void in the professional lifecycle of the worker. To facilitate this role expansion, a universal platform and process are implemented to bridge the gap between unemployed workers and available professional development and job training/re-training resources. The recruitment community is strategically and ideally positioned to bridge gap between the two in order to facilitate ease of access and delivery of available resources to unemployed workers, thereby ensuring continual professional development and maintenance of up-to-date jobs skills. In this implementation, the role of the professional recruiter is therefore expanded to include providing job seekers with career assessment/development/guidance, and job training/re-training referral services along with to the usual job placement services they provide. In return, the recruitment community as a whole stands to benefit, as the expanded role of the recruiter will allow them to form agent/client relationships with job seekers in the same way as real estate agents do with home sellers. The outcomes of this role expansion are a wider range of revenue generating opportunities for recruiters and wider placement options for job seekers. In addition, it will level the playing field for unemployed workers ensuring their continual professional development and maintaining their marketability as assets of the labor market with up-to-date job skills.

The recruitment community and employers alike have long held a negative perception of unemployed workers that runs counter to the goal of reducing unemployment and if allowed to continue without remedy, there is little chance of reducing unemployment through the efforts of recruitment. Unfortunately, unemployed workers bear the stigma of being labeled as “damaged goods” and this perception must be changed universally if we are to be successful in reversing the growing unemployment crisis. To accomplish this, it is necessary to change the negative perception of unemployed workers by creating a demand and a place for them in the overall scheme of the labor economy. As companies have grown increasingly disinterested in unemployed workers, they have placed greater demands on recruiters to supply them with candidates with up-to-date skills. Recruiters, desiring to give their client companies what they want and therefore earn a placement fee, have tended to limit their recruiting efforts to recycling passive candidates among employers, i.e., those individuals who are already working with a company's competitors. Consequently, recruiters have acquiesced to the demands of their clients and unwittingly failed to recognize the vital role they can play in creating a demand and a place for unemployed workers as a dynamic and integral part of the labor economy. This invention provides the infrastructure, methods and process to allow the recruitment community to assume a proactive role in changing the perception of the expanding pool of unemployed talent and leading way to converting it to a highly valued asset of the labor economy. This will be accomplished by bringing about a paradigm shift in the relationship between the recruitment community and job seekers in general, but more specifically between the recruitment community and unemployed workers. Central to this paradigm shift is the expansion of the role of the recruiter from that of “recycler of passive candidates” to that of holistic career agent, who invests in, develops and markets the product of their trade.

The entire recruitment process, as it stands today, is broken and must be reformed if it is to be used to help solve the unemployment crisis and facilitate re-employment of unemployed workers. The system wrongly places a premium on and rewards recruiters for their ability to recycle passive candidates between client companies that are seeking to fill job openings. They thereby exclude unemployed workers who need jobs the most. Recruiters do not view unemployed job seekers as marketable assets and companies do not view them as highly valued and desirable products. In addition, the thousands of recruiters within the recruiting industry have failed to come together in a unified way to define the industry and establish industry wide standards and best practices. The current unemployment crisis represents the ideal opportunity for the thousands of recruitment professionals to marshal their collective strengths, expertise and resources to support an industry wide reform of the recruitment industry. To bring about a reform of the recruitment industry, the resources and efforts of the key stakeholders (job seekers, companies, recruiters and government) must all be aligned and working to ensure the industry wide goal of professional, personal and economic stability of all eligible workers including the optimum re-employment of the unemployed. The professional recruiter must therefore become the owner and driver of the entire recruitment process and who effectively manages conditions that affect the supply and demand of his product (job seekers). Unemployed job seekers must be transformed from a high volume/low demand commodity to a low volume/high demand specialty. Companies must be given reasons to become willing and eager consumers of available innovative talent. The government must become facilitator of the appropriate legislative milieu for productive business exchange. This invention creates the means and impetus to drive reform of the recruitment industry that is necessary for the ongoing management of unemployment and for sustaining the professional, personal and economic stability of workers across periods of employment and unemployment.

The recruitment process is a time honored and laborious series of tasks involving the mapping of job seekers' skills (resumes) to employers' job specifications (job postings). From its genesis, the earliest method of matching job seekers to job specifications was the posting of job advertisements in newspapers and magazines noting the availability of a certain position. Job seekers or “candidates” prepared resumes and submitted them to various employers who were advertising a particular job opening. Over the years, the method of advertising jobs has evolved from newspaper and magazine advertisements to modern online (electronic) job boards. A plethora of online job boards—both public and private—have emerged that have databases containing millions of resumes and job postings. Electronic job boards have quickly become widely recognized as a standard tool for conducting job searches. Public job boards such as Monster, CareerBuilder, etc. are centralized websites that allow companies to post job openings in one central location. Such job boards may have many hundreds or thousands of companies posting or advertising their job openings. Conversely, individual candidates can post their resumes in a centralized database. Typically, public job boards do not charge candidates for accessing companies' job postings nor are candidates charged for the right to post their resumes in the public job board's database. However, companies typically are charged for the right to post a certain number of job openings for a period of time. In addition, they are charged for access to searching the database of candidates' resumes. In this fashion, the public job board generates revenue. Consequently, many companies have taken to advertising their available positions on their respective company websites because of the costs associated with the use of public job boards. However, exposure may be limited because not all search engines are created equal. There is a strong possibility that the particular search engine that a job seeker is using to conduct his job search may not pick up the company's website. Therefore, qualified job seekers may not be aware of a particular company and may not therefore become aware of the existence of a particular job posting on that company's website. Although electronic job boards are a powerful job search tool, they have yet to be leveraged to help unemployed job seekers find jobs.

The majority of job seekers posting and submitting their resumes over electronic job boards are unemployed. When workers become unemployed or decide to look for another job, their first response is usually to turn to electronic job boards in search of available positions to which they will submit their resume. They may also post their resume to a searchable database of one of the public job boards such as Monster or CareerBuilder that have the capability of storing resumes. From that database, the job seeker may forward their resume to jobs in which they are interested. Additionally, they may make their resume available for viewing by interested recruiters or companies that may have open positions. Job seekers follow these steps with the expectation that either a company or a recruiter will discover their resume and contact them for a job interview, which they hope will lead to job placement. Unfortunately, in view of the fact that recruiters and companies have little or no interest in pursuing unemployed job seekers to fill job openings, they are not likely to have much success finding a job using either public or private electronic job boards, except on rare occasions.

Another limitation of public job boards is the inherent inability of existing search engines to locate the right candidates' resumes and appropriately map the right skills to a particular set of job specifications. Finding the right person to fill an open position is a major challenge for employers and recruiters because the process of recruiting new employees is inefficient, time-consuming, and costly. The same is true from a candidate's perspective, as finding the right job is also a significant challenge for most candidates because the process of finding the right job that matches a candidate's unique set of skills is also inefficient, time consuming and costly. The proliferation of web-based technology for recruiting and matching has expanded employers' and job seekers' ability to find each other, but it has made the process of recruiting and matching increasingly complicated. Companies focus on recruiting the right people to fill positions, but they do not have an efficient, cost effective process to help them find the right people they want to hire for a specific job. Job seekers focus on finding the right position, but they do not have a complete understanding of which specific skills a job requires and what companies value most.

In recent years the number of technology companies attempting to solve issues in the recruiting and matching process has grown tremendously. The proliferation of web-based technologies includes a wide range of applicant tracking systems, data extraction methods, new search technologies, and processes attempt to match the appropriate job seekers with open positions. Applicant tracking systems collect job description and job seeker information (resume), but they do not have precise matching between the required elements of the job specification and the skills and experience of the job seeker.

Data extraction methods are based on individual words, which do not capture nuances in various types of skills and experiences. Extraction also relies upon large databases of verified data. Most extraction technology providers do not have adequate databases of verified data or high quality validation.

Existing search and matching technologies mostly rely on keywords linked with Boolean operators to launch searches and retrieve search results, but using keyword-based searches does not provide precise matching results. The key words can be taken out of context and result in poor search matches. For example, for the phrase “quality assurance,” existing technologies look for “quality” and “assurance” as separate results and bring back results that are not relevant to the whole phrase “quality assurance.”

There are a number of recruitment technology companies attempting to automate the matching process. Their technology, generally known as an applicant tracking system (ATS), also uses keyword searching with Boolean operators to execute their matching process. Again, keyword searching has its limitations in determining subtle differences in terminology, spelling, format, and case between the words used in the employer's job description and the words used in a candidate's resume. Moreover, these search techniques usually are not capable of performing relationship logic or quantitative evaluation of the applicants' skills and experience. Therefore, qualified candidates may be overlooked, and unqualified candidates selected may be selected.

Online job boards all provide search capabilities to perform matching, but they are also using key words with Boolean operators, which result in imprecise matches or even no matches. A user does not know if a keyword will find a match until they enter the keyword and actually run the search. This process is frustrating and leads to too much backtracking.

Although electronic job boards are widely recognized as a standard and powerful job search tool, they are of little value to unemployed workers in their ability to help them become re-employed. Their greatest value is to companies and recruiters who wish to cast a broad advertising net for their job postings with the hope of attracting the attention of passive candidates. Unfortunately, the recruitment community has not taken a leadership role in driving any aspects of the recruitment process that address the skyrocketing unemployment situation. The recruitment community does not own or operate any of the major electronic job boards and neither have they defined standards for posting and searching jobs and resumes to improve or simplify the process of mapping the right candidates to the right positions. This invention includes the creation of a central clearinghouse that offers exposure for job postings and job seekers with up-to-date skills at a fraction of the cost of public job boards for companies and recruiters.

Fortunately, the US Department of Labor/Employment and Training Administration (USDOL/ETA) has developed a national database of rich occupational information known as O*NET. Information from this database forms the heart of O*NET OnLine, an interactive application for exploring and searching occupations. One of the features of O*NET OnLine is O*NET Code Connector, which is a tool designed specifically for job coding professionals to simplify the process of matching job orders to an occupation in the O*NET-SOC (Standard Occupational Classification) system. The O*NET-SOC taxonomy is based on the BLS's (Bureau of Labor Statistics) Standard Occupational Classification system and currently includes 965 occupations. To keep up with the ever changing occupational landscape, the taxonomy is periodically revised and updated so new occupations and codes will be reflected as they emerge. With a powerful keyword search and a concise, at-a-glance overview of occupations, this web application makes interactive job coding fast and simple. This innovation integrates the universal functionality of O*NET Code Connector into its universal mapping template to achieve a level of accuracy and efficiency in matching candidates' skills to job specifications and vice versa where all previous attempts of online job boards have failed. Candidates' skills and job specifications alike can be mapped to the same universal O*NET-SOC, thereby greatly improving the seaching and matching capability not seen heretofore.

### SUMMARY OF THE INVENTION

The current unemployment crisis has evolved to its current level due to the lack of an infrastructure and a systematic process for managing unemployment that would prevent workers who would become unemployed at one time or another from falling into a state of economic and professional impoverishment. It is therefore the objective of the present invention to implement a platform and a collaborative process for key stakeholders—unemployed workers, recruiters, companies and governmental agencies—to use in carrying out employment/unemployment-related business transactions to preserve the economic, professional and personal integrity of workers over the continuum of their careers. One of the main problems addressed is the loss of group-related benefits and services when workers lose their employee (group) status and transition to an unemployed (solitary) status. Currently employees receive a range of benefits and services that are directly related to them belonging to their employer group. This includes healthcare benefits at a reduced group rate, the convenience of having income and Social Security taxes withheld from their earnings and paid to the appropriate taxing authorities, and some measure of safety net protection from unemployment insurance benefits and workers compensation in the event of job loss or work related injury. When employees transition from the group status (employer) to a solitary status (unemployed), they automatically lose all of the group benefits and the convenience of employer-provided services that formed the basis of their economic, professional and personal security, which they received from their employment. When this invention is implemented, unemployed workers will, for the first time, be able retain all of the benefits of group membership that they received from their employer through their relationship with a non-employer group-based organization (infrastructure).

A further objective of this invention is to create an Affinity Services Organization™ (ASO) as a perpetual organizational infrastructure for managing the transition of employees from employment to unemployment and back to employment.

Another objective of the present invention is to create an employment accommodation for unemployed workers known as “universal employees™” (UE) to give them the option of accepting contract placements (CP) opportunities from contract employers (CEs) through the ASO™ without sacrificing the group benefits and services they received as a traditional employee.

A further objective of the present invention is to allow the ASO™ to function as billing agent and intermediary between “universal employee™” and contract employer (CE) for the facilitation of contract placements (CPs). The ASO™ shall be accountable for billing the CE for CPs with “universal employees™” and shall include in the contract billable rate (CBR) for UE the cost of employer contributions for FICA, FUTA and SUTA. The ASO™ shall also certify that CE has appropriate WC coverage for UE and collect and deposit appropriate FICA, FUTA and SUTA taxes into designated tax accounts established on ASO™ portal for subsequent collection by taxing authorities.

A further objective of the present invention is to allow independent contractors to accept contract placements (CPs) through the ASO™ and have local, state and federal taxes withheld from the contract billable rate (CBR) and deposited into designated tax accounts established on ASO™ portal for subsequent collection by taxing authorities.

A further objective of the present invention is to allow the ASO™ to function as the “payroll processor of record” for “universal employees™” and independent contractors.

A further objective of the present invention is to allow the ASO™ to provide the infrastructure and electronic capability for the efficient administration and application of severance awards to prolong the economic stability of UWs.

A further objective of the present invention is to allow local, state and federal taxing authorities to receive timely and accurate payment of tax revenues from “universal employees™” and independent contractors via a user specific dashboard (USD) established on ASO™ portal.

A further objective of the present invention is to allow companies the flexibility of utilizing “universal employees™” or independent contractors as needed to augment their interim, cyclical or seasonal staffing needs without being compelled to hire them as traditional employees.

A further objective of the present invention is allow unemployed workers (UWs) the opportunity to preserve their professional and personal stability through a process of continually updating and developing their job skills during periods of unemployment.

A further objective of the present invention is to allow UWs the opportunity to preserve their economic stability by the use of an FDIC severance account for funding the extension of group healthcare benefits.

A further objective of the present invention is to allow recruiters the opportunity to obtain placement agent subscriber (PAS) status for the provision of the full range of CMS services (CADG, JTR, ES, ER and TLO) to UWs.

A further objective of the present invention is to allow PASs the opportunity to establish agent/client relationships with UWs and thereby expand their revenue generating potential.

A further objective of the present invention is to allow employers the opportunity to obtain authorized company subscriber (ACS) status for the provision of CMS services excluding TLO (CADG, JTR, ES, ER and TLO) to current or recently separated employees.

A further objective of the present invention is to allow ACSs the opportunity to establish agent/client relationships with current or recently separated employees (UWs) and thereby receive access to ASO™ database including job posting and candidate search privileges and/or remuneration or other consideration upon placement of UWs.

A further objective of the present invention is to provide local, state and federal taxing authorities with a universal tax revenue collection/reporting process for “universal employees™” and independent contractors.

Another objective of this innovation is to establish an electronic clearinghouse for initiating and reconciling business and financial transactions relating to the transition of workers from employment to unemployment and back to employment, placement of “universal employees™” and independent contractors, billing, transfer of funds, career and professional development and the tracking of outcomes or workers.

A further objective of the present invention is to provide a universal platform for centralized aggregation of professional development and job training/re-retraining resources.

A further objective of the present invention is to provide a universal process for capturing longitudinal career/employment data for UWs.

A further objective of the present invention is to create a national organization whose mission is to maintain an awareness of factors and conditions affecting unemployed workers and to support legislation that strengthens and preserves the economic, professional and personal integrity of UWs. Initially, the ASO™ will promote legislation to extend certain employee rights and privileges to independent contractors and the creation of a supplemental unemployment insurance safety net, i.e. a pre-tax severance for non-traditional as well as traditional employees.

Another objective of the present invention is to create the infrastructure, methods and processes to facilitate a paradigm shift in the relationship between recruiters and job seekers.

A further objective of the present invention is to create the means and impetus to drive reform of the recruitment industry.

A further objective of the present invention is to create a global electronic job board with universal candidate/job search and match criteria that align with O*NET-SOC.

A further objective of the present invention is to create a high quality resume database with O*NET-SOC as the primary search criteria.

A further objective of the present invention is to create a high quality job posting database with O*NET-SOC as the primary search criteria.

A further objective of the present invention is to provide companies with an economical option for global advertising of job postings.

A further objective of the present invention is to provide recruiters with an economical option for global exposure of their job postings and their highly skilled candidates.

A further objective of the present invention is to provide unemployed job seekers a global option for exposure of their career-enhanced resumes reflecting up-to-date job skills.

These objectives are not meant to be limiting and are illustrative only. Other objectives may become apparent to those skilled in the art from the accompanying figures, descriptions and claims.

### BRIEF DESCRIPTION OF DRAWINGS

The accompanying drawings illustrate various non-limiting inventive aspects in accordance with the present disclosure:

FIG. 1 illustrates the logic flow for managing unemployment and ongoing career development of unemployed workers and for tracking their long-term outcomes through an Affinity Services Organization™ (ASO™), which is created as a perpetual infrastructure™ according to one embodiment of this disclosure.

FIG. 2 illustrates the logic flow for sustaining the economic and professional stability of unemployed workers who elect to become universal employees through ASO™ membership during periods of unemployment according to one embodiment of this disclosure.

FIG. 3 illustrates the logic flow for the Affinity Services Organization™ (ASO™) as payroll processor of record for universal employees according to one embodiment of this disclosure.

FIG. 4 illustrates the logic flow for establishment of agent/client relationship between unemployed workers and Authorized Company Subscribers or Placement Agent Subscribers and setup on ASO™ database.

FIG. 5 illustrates the logic flow for the candidate placement and fee generation process according to one embodiment of this disclosure.

FIG. 6 is a high-level diagram that outlines the Universal Mapping of job seekers to job postings according one embodiment of this disclosure.

FIG. 7 is a diagram of the electronic clearinghouse over which the four (4) key stakeholders collaborate and conduct business transactions according to one embodiment of this disclosure.

### DETAILED DESCRIPTION

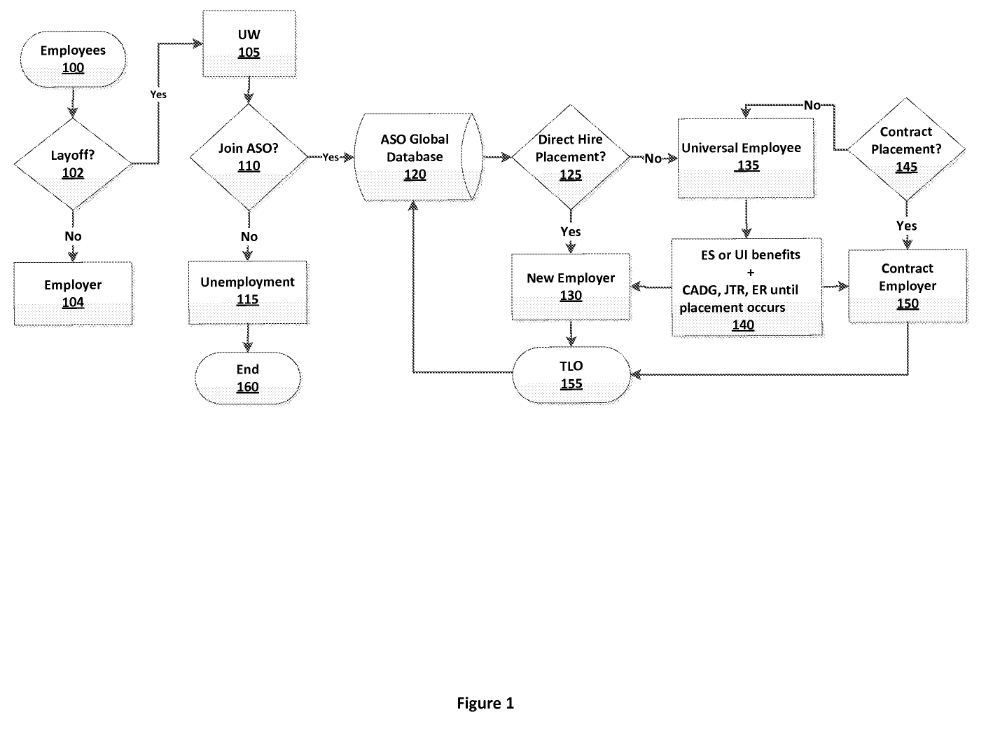

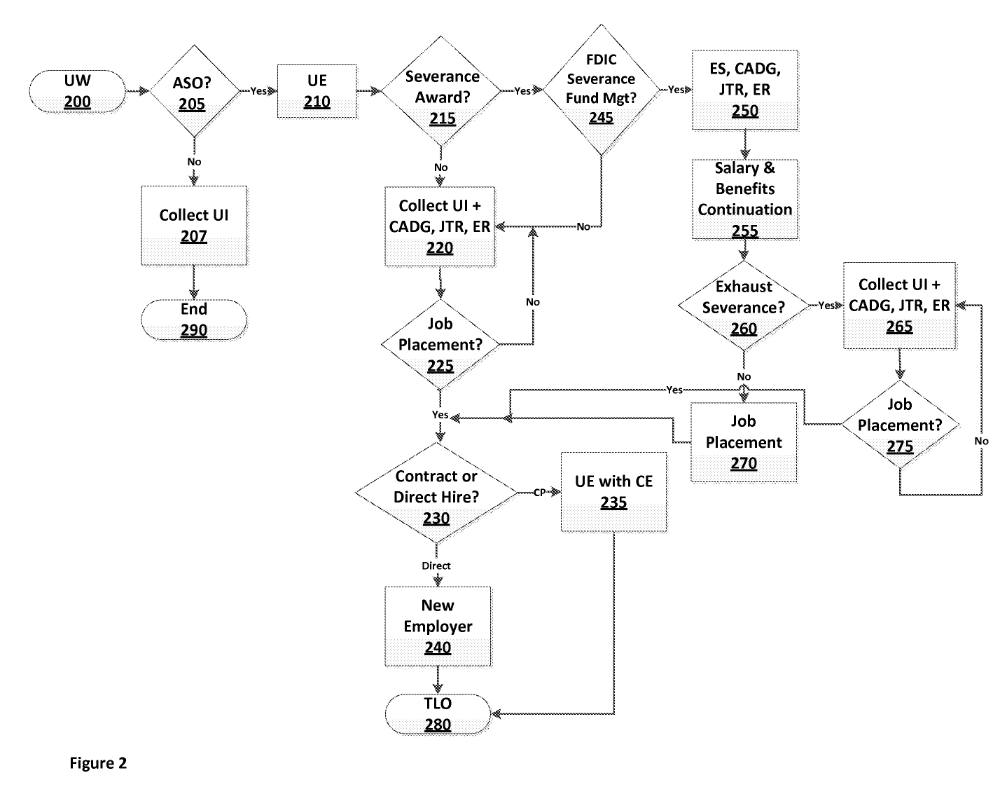

FIG. 1 illustrates the logic flow for managing the transition of workers from a state of employment to unemployment and back to employment through an Affinity Services Organization™ (ASO™), which is created as a perpetual organizational infrastructure according to one embodiment of this disclosure. In this embodiment of the logic flow, employees 100 who are targeted for layoff 102 from their employer 104 are given the option to become a member of the ASO™ 110 or to refuse membership and go directly on unemployment 115. Unemployed workers 105, who elect ASO™ membership, are entered into the ASO™ Global Database 120 for global exposure to prospective employers. Upon becoming a member of the ASO™ 110, unemployed workers 105 are assessed immediately and considered for direct hire placement 125. Those who are successful are placed with a new employer 130. Unemployed workers 105, who do not obtain direct hire placement 125, become universal employees 135 and are eligible to accept contract placements 145 with the ASO™ acting as payroll processor of record for collection of FICA, FUTA, SUTA and income taxes for the universal employee. This contract placement results in a work assignment with a contract employer 150 without the concern for accurate recording and reporting of appropriate employee taxes. In addition, universal employees 135 are eligible to receive the full range of Career Management Services to ensure their skills remain current during period of unemployment, increasing the appeal to prospective employers. If universal employee 135 is not successful in obtaining contract 145 or direct hire placement 125 at first attempt, they continue to receive economic stability services through severance management or unemployment benefits while simultaneously receiving career management services (CADG, JTR and ER) 140. Universal employees 135 receive enhanced re-employment services 140 until placement occurs with a new employer 130 or with a contract employer 150. In this embodiment, universal employees 135 who separate from their employer 104 with severance awards are required to exhaust their severance awards before becoming eligible to receive unemployment benefits 140 as shown in FIG. 2, thereby reducing the escalatory impact on State Unemployment Insurance (SUI) funds and Federal Unemployment Insurance (FUI) fund. All workers whether direct hire placements 125 or contract placements 145 remain in the ASO™ Global Database 120 and are setup for tracking their long-term outcomes 155.

FIG. 2 illustrates the logic flow for sustaining the economic and professional stability of unemployed workers who elect to become universal employees through ASO™ membership during periods of unemployment according to one embodiment of this disclosure. In this embodiment of the logic flow, the unemployed worker 200 who elects ASO™ membership 205 converts from the status of the unemployed worker 200 to universal employee 210, which opens employment options heretofore unavailable to unemployed workers. Universal employees 210 who separate from their employer with a severance award 215 are eligible to participate in the FDIC Severance Fund 245 for severance management, which is a unique feature of the ASO™ Economic Stability (ES) module. In addition to severance management 245, universal employees 210 receive the full range of Career Management services (CMS), which include Career Assessment/Development/Guidance services (CADG), Job Training/Re-training (JTR) and Enhanced Re-employment (ER) services 250. One of the main benefits of the ES module of 250 is the continuation of salary and group benefits 255, which is funded by drawing down from the FDIC Severance Fund 245. During the severance management period, the universal employee 210 may obtain job placement 270, which may be contract placement 235 or direct hire 240. Universal employees 210 who separate form their employer without a severance award 245, are eligible to collect unemployment benefits while simultaneously receiving CADG, JTR and ER services 220. Enhanced re-employment (ER) 220 is continually pursued on behalf of the universal employee 210 until contract or direct hire job placement 230, 235, 240 is achieved. In both job placement scenarios 225 and 275 in which the universal employee does not obtain immediate job placement, they continue to receive career management services 220 and 265 with a strong focus on ER until the goal of either contract placement 235 or direct hire placement 240 is achieved.

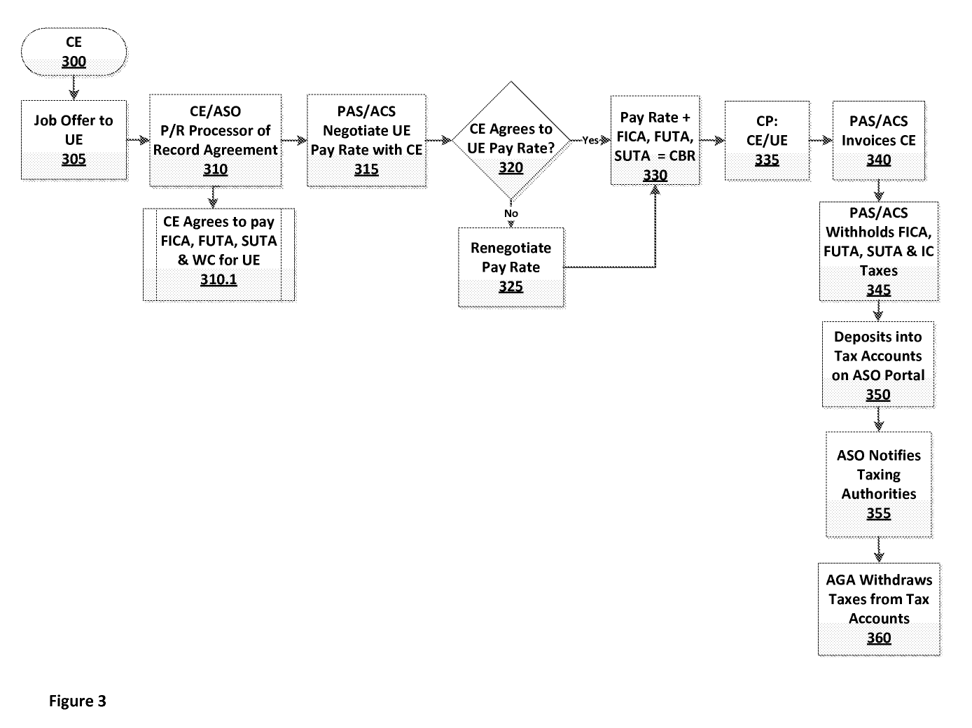

FIG. 3 illustrates the logic flow for the Affinity Services Organization™ (ASO™) as payroll processor of record for universal employees according to one embodiment of this disclosure. In this embodiment of the logic flow, the contract employer 300 extends a job offer to a universal employee 305. The next step in the process requires the execution of a Payroll Processor of Record agreement between the contract employer and the ASO™ 310 in which the contract employer agrees to pay the employer's portion of FICA, FUTA and SUTA taxes and to provide Workers Compensation coverage for the universal employee 310.1. Following the execution of this agreement, the Placement Agent Subscriber (PAS) or the Authorized Company Subscriber (ACS), whichever is the agent for the universal employee, negotiates with the contract employer to agree upon a the pay rate for the universal employee 315, which includes a placement fee margin. When the contract employer and the PAS/ACS agree on a pay rate for the universal employee 320, the PAS/ACS then quotes the contract billable rate (CBR) to the contract employer 330 and a contract placement is then made between the contract employer and the universal employee 335. The PAS or ACS invoices the contract employer for hours worked by the universal employee 340, withholds appropriate FICA, FUTA, SUTA and income taxes from gross earnings 345, and deposits them into the appropriate tax accounts setup on the ASO™ portal 350. The ASO™ is then accountable to notify the proper taxing authorities of the availability of tax revenues 355. Authorized governmental agencies (AGA) electronically withdraw tax revenues from tax accounts on ASO™ portal 360.

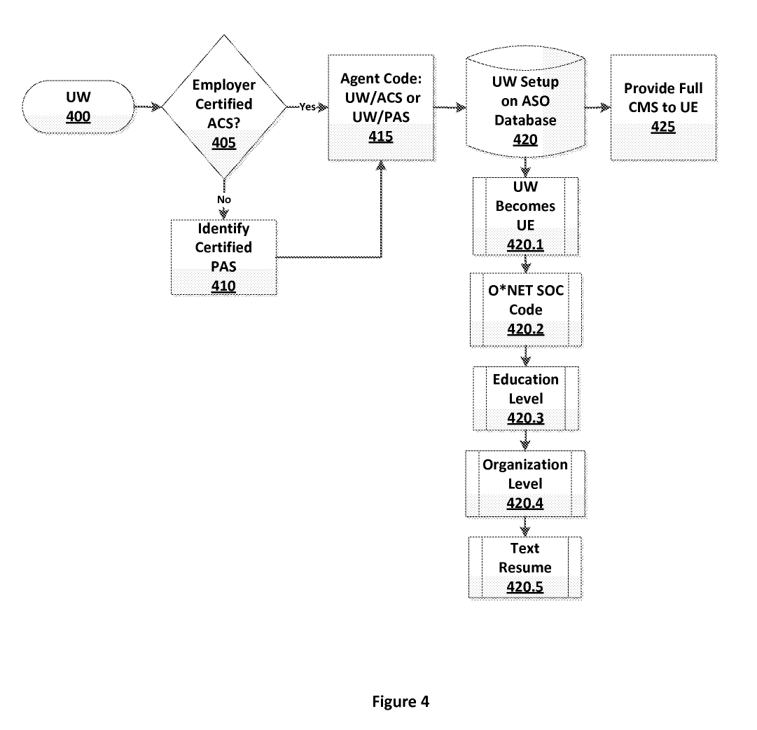

FIG. 4 illustrates the logic flow for establishment of agent/client relationship between unemployed workers and Authorized Company Subscribers (ACS) or Placement Agent Subscribers (PAS) and for setup on ASO™ database. Establishment of agent/client relationship between unemployed workers and Placement Agent Subscribers or Authorized Company Subscribers is central to the reform of the recruitment industry and to ensure that unemployed workers are brought out of obscurity and promoted as highly valued and marketable assets of the labor economy. In the same manner as a real estate agent represents a home seller in the sale of his home, so will the relationship be with the PAS/ACS and the unemployed worker. The PAS/ACS develops, markets, promotes and lists his products in an widely publicized open forum (ASO™ Global Database) to increase the probably of capturing the attention of potential buyers in the same manner as the real estate agent develops, markets, promotes and lists his products in the Multiple Listing Section (MLS) for realtors. In the embodiment of this logic flow, the unemployed worker (UW) 400 first checks to determine if their current or most recent employer is a certified ACS 405. If they are, the UW establishes his initial agent/client relationship with his ASO™ certified employer 415 since his employer is familiar with the UW's background and has historical data that can readily be uploaded into the ASO™ database, efficiently accomplishing the task of setting up the UW on the ASO™ database 420. If the employer is not a certified ACS, the UW searches for a PAS 410 that is certified to provide Career Management Services (CMS) in the specific industry or professional discipline of the UW and selects the PAS of his choice. Placement Agent Subscribers may also seek out qualified UWs with experience in specific industries and professional disciplines to initiate an agent/client relationship. Formalization of the agent/client relationship is accomplished by the assignment of a unique Agent Code 415 to the UE's profile that identifies the PAS or ACS sponsoring agent for the UE. The Agent Code 415 is critical in determining the identity of the agent who is accountable for delivering all CMS services and support 425 to the UE and for determining with whom to split placement fees in the event the UE is placed by other than the sponsoring agent. The manner in which UEs are setup 420 in the ASO™ database is also of critical importance as all database entries conform to one universal record template where extreme accuracy and consistency are required to ensure integrity of job seeker data records. After setup 420, the unemployed worker (UW) becomes a universal employee (UE) 420.1. Each job seeker's record consists of the appropriate O*NET SOC (Standard Occupational Code) 420.2, Education Level 420.3, Organization Level 420.4 and a text resume 420.5.

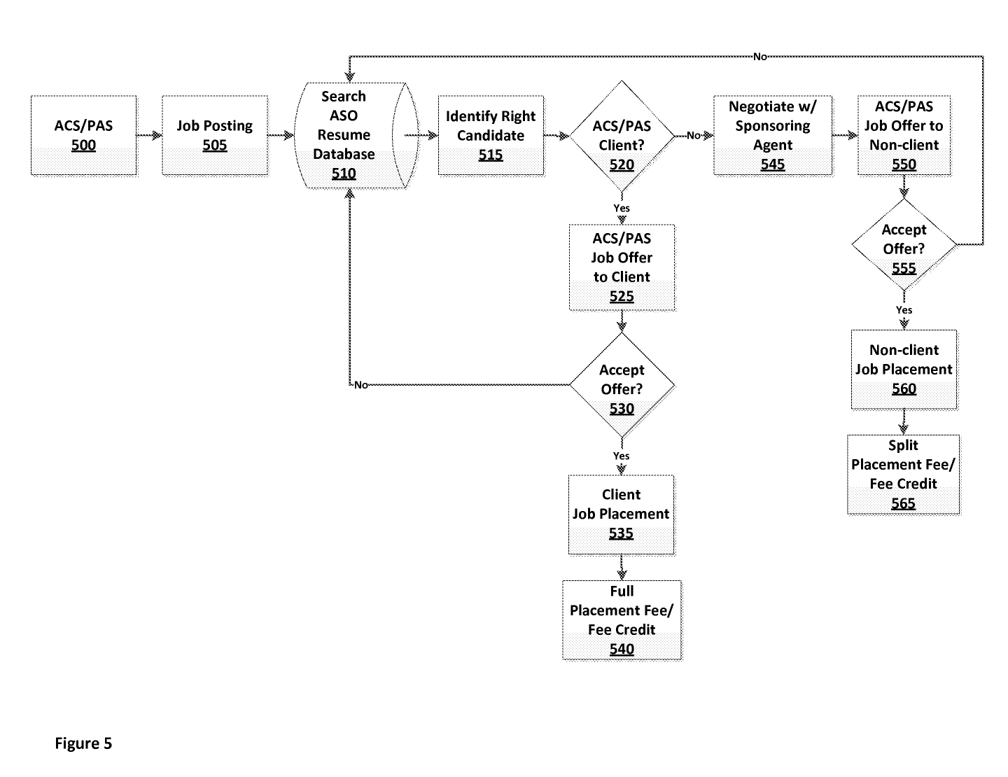

FIG. 5 illustrates the logic flow for the candidate placement and fee generation process according to one embodiment of this disclosure. In the embodiment of this logic flow, the candidate (client) placement process begins with an ACS or PAS 500, who has a job posting 505 to be filled. The ACS/PAS first searches the ASO™ resume database 510 to identify the right candidate 515, whose job skills and background match the requirements of the job posting 505. Upon identifying the right candidate, the ACS/PAS determines if the candidate identified is one of their clients 520. If the candidate is a client of the ACS or the PAS, then the ACS or the PAS proceeds to make a job offer to the client 525. lithe offer is accepted 530 by the client, a job placement is made 535 and a full placement fee is due to the PAS or a full placement fee credit is due to the ACS 540, which means that the ACS pays nothing for placing their client to fill their own job posting. On the other hand, if the candidate identified by the ACS/PAS 520 is not a client of the ACS or the PAS, the ACS of the PAS contacts the sponsoring agent to negotiate the placement fee and the fee split 545. Upon reaching agreement, the ACS/PAS proceeds to make a job offer to the non-client 555. If the job offer is accepted, a non-client job placement is made 560 and the placement fee is split between the placing ACS/PAS and the sponsoring ACS/PAS 565. In both scenarios where the job offer may be rejected 530 and 555, the candidate remains in the resume database 510 and is available to be considered for future opportunities.

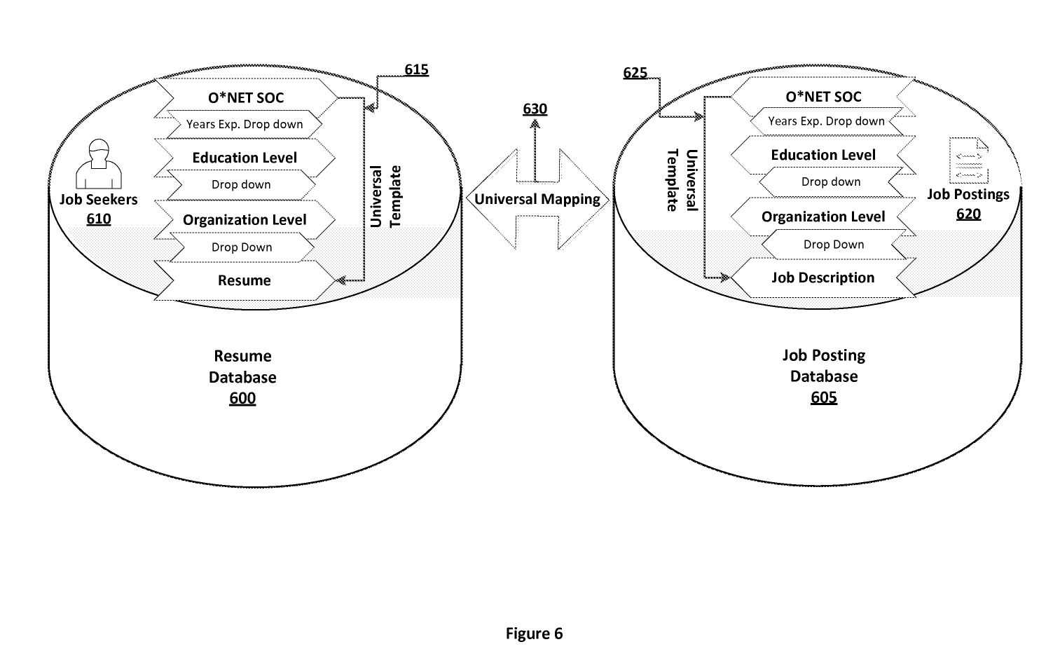

FIG. 6 is a high-level diagram that outlines the Universal Mapping of job seekers to job postings according one embodiment of this disclosure. Universal Mapping provides a significant improvement over keyword searches, which is most widely used in existing search and matching technologies of nearly all job boards today. Job seekers 610 are entered into the resume database 600 following the universal template for job seekers 615. Job postings 620 are entered into the job posting database 605 following the universal template for job postings 625. Highly accurate universal mapping 630 search results are obtained when the desired search criteria are entered into the search engine for resumes or job postings. For example, an ACS or PAS may hone their search for the right candidates to match a particular job posting by entering the appropriate O*NET SOC code along the exact number of years of experience or a range, the exact education level desired or a range, and the exact organization level or a range. Conversely, a job seeker may follow the same process for finding positions in the job posting database that match his/her background.

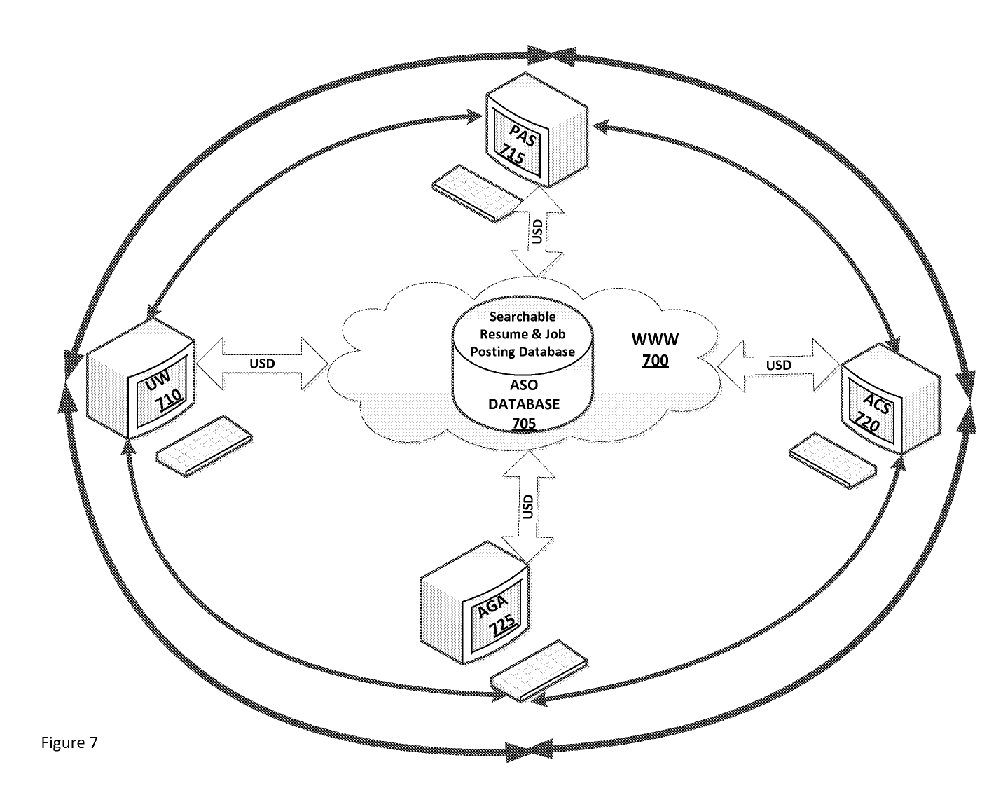

FIG. 7 is a diagram depicting the example global portal (electronic platform) that allows the collaborative interaction and processing of business transactions between the four (4) key stakeholders of the Unemployment Management System according to one embodiment of this disclosure. In the embodiment of this diagram, the ASO™ global database 705 resides on-the Worldwide Web 700 over which the key stakeholders collaborate and conduct business transactions relative to the Unemployment Management System and the prescribed methods for preserving the economic, professional and personal stability of unemployed workers. Due to the need for a high degree of data consistency and accuracy, either a PAS 715 or an ACS 720 enters UWs 710, who elect to become members of the ASO™, into the database 705 following the Universal Mapping template. This establishes the agent/client relationship between the UW and the PAS or ACS. If a worker is employed by or is recently separated from a company that has acquired ACS status, the initial agent/client relationship is between the UW and his/het ACS employer since unless compelling reasons dictate otherwise. In the context of this innovation, establishment of the agent/client relationship is critical in determining how and from whom the UW receives all CMS services and support during periods of unemployment. It also establishes the basis for the generation of placement fees or fee credits to the sponsoring PAS/ACS when clients are placed. ACSs 720 post their job openings in the ASO™ job posting database, following the Universal Mapping template for job postings, which allows PASs and other ACSs and ASO™ job seekers to see them and apply or present qualified candidates. An ACS 720 has the option of using the proprietary Universal Mapping technology to search the global database for candidates to fill their job openings or they may enlist the services of a PAS 715. AGAs 725 make the myriad of job training/re-training resources available to the ASO™ for easy access by PASs, ACSs and UWs. As the ASO™ is a central clearinghouse, other private organizations may also house the job training/re-training resources on the ASO™. AGAs 725 that are taxing authorities have access to designated tax accounts stored on the ASO™ portal by way of a User Specific Dashboard (USD) and are able to electronically withdraw tax revenues collected from the earnings of UEs and independent contractors. In addition, certain AGAs require access to longitudinal data captured on workers for planning purposes. Access is made possible by obtaining the proper authorizations and assignment of user logons.

It is believed that the system and method of the present invention and many of its attendant advantages will be understood by the foregoing description. The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. In addition, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed:

1. A novel use of an affinity organization hereinafter referred to as an “Affinity Services Organization™” (ASO™) through which a Career Management System (CMS) is delivered to unemployed workers (UWs) which shall consist of five (5) service modules:
Career Assessment/Development/Guidance (CADG), Job Training/Re-training referral (JTR), Economic Stability (ES), Enhanced Re-employment (ER) and Tracking Long-term Outcome (TLO) of UW through collaborative efforts of the following key stakeholders:
(a) unemployed workers (UW) seeking Career Assessment/Development/Guidance (CADG), Job Training/Re-training referral (JTR), Economic Stability (ES) and Enhanced Re-employment (ER) services,
(b) placement agents (PA) seeking to establish agent/client relationships with unemployed workers (UW) for provision of CADG, JTR, ES, ER and TLO services which ultimately lead to job placement of UWs with revenue generation opportunities for PAs,
(c) companies (CO) seeking to assist in transitioning unemployed workers to said ASO™, to post job openings and/or identify suitable candidates to fill job openings either independently or with the assistance of a placement agent (PA) and,
(d) governmental agencies (GA) seeking to make job training/re-training opportunities available to unemployed workers, to determine or verify federal, state or local payroll withholdings and tax deductions for regulatory compliance and to collect same from designated accounts, or to access captured data for longitudinal analyses and planning relative to unemployed or re-employed labor force.

2. The method of claim 1 including means to establish said ASO™ as a membership organization (perpetual infrastructure) to which unemployed workers (UW) will transition upon separation from their employer for delivery of Career Management System services (CMS) in preparation for job placement.

3. The method of claim 2 including means for said UW of said ASO™ to receive and accept job offers from companies wishing to engage them in direct-hire or contract work opportunities, and whereby acceptance of a direct-hire offer from said company by said UW will result in a new traditional employee/employer relationship between said UW and said company (employer);
and whereby acceptance of a contract offer from said contract employer (CE) by said UW will result in a contract placement (CP) between said CE and a said UW hereinafter referred to as “universal employee” (UE).

4. The method of claim 3 further comprising the step to define “universal employee” (UE) as a member of said ASO™ who is not in receipt of any direct-hire offer from any company but who is available to accept contract offers from said CE wishing to engage them for a specified duration of time, and whereby said UE is entitled to the same protection, rights, privileges and coverage afforded the traditional employee and agrees to be bound by the same legal statutes governing payment of appropriate income and social security taxes and other authorized payroll deductions from eligible contract earnings.

5. The method of claim 3 further comprising the step to ensure that said contract employer (CE) that enters into a contract agreement with said universal employee (UE) agrees to pay as part of the contract billable rate (CBR) the appropriate FICA, FUTA and SUTA tax rate and to provide certification of appropriate Workers Compensation coverage for said universal employee (UE) for the duration of the contract agreement.

6. The method of claim 2 including means to prolong or sustain the economic stability of said UW by establishing and maintaining an interest-bearing FDIC Severance Fund account for voluntary deposit of severance awards by said UW who separates from their employer with severance award, from which salary, group benefits, FICA, and other appropriate federal, state or local income tax deductions are made periodically by said member until said severance award is exhausted or job placement occurs.

7. The method of claim 6 including means to pay for the continuance of said UW's group health insurance benefits from prior employer or for another group health insurance as determined by whichever may be more competitive or which may provide the greater coverage.

8. The method of claim 4 further including the means for said ASO™ to be designated as “payroll processor of record” for said UE who enters into a CP with said contract employer (CE) and both parties mutually agree to establish and maintain an independent working relationship for a specified duration of time.

9. The method of claim 8 further comprising the step for said ASO™ to collect appropriate FICA, FUTA, SUTA and local, state and federal income taxes from contract earnings of said universal employee (UE), and to deposit taxes into appropriately designated tax accounts set up on ASO™ portal.

10. The method of claim 9 further comprising the step for authorized governmental agencies (AGA) to access appropriate tax accounts via a role-specific gateway/dashboard for withdrawal of taxes collected on behalf of universal employees.

11. The method of claim 2 including means for maintaining connectivity with and tracking the long-term outcome (TLO) of UW through period of employment/unemployment and beyond.

12. The method of claim 1 including the means for said unemployed workers (UW) to establish membership status with said ASO™ thereby making said UW eligible to receive the full range of ASO™ members' Career Management System (CMS) services which shall include Career Assessment/Development/Guidance (CADG), Job Training/Re-training referral (JTR), Economic Stability (ES), Enhanced Re-employment (ER), Tracking of Long-term Outcome (TLO), resume and profile development and all other rights, benefits and privileges of said ASO™ members.

13. The method of claim 12 further comprising the step for said unemployed worker (UW) to identify a Placement Agent Subscriber (PAS) to provide said ASO™ Career Management System (CMS) services in the specific industry and professional discipline of said UW, and for the execution of an agent/client agreement between said UW and said PAS and for the entry and setup of said unemployed worker (UW) into said ASO™ database.

14. The method of claim 13 further comprising the step for establishing the basis for said Placement Agent Subscriber (PAS) to receive a full or split placement fee upon direct-hire or contract placement of said unemployed worker (UW) with whom agent/client relationship has been established.

15. The method of claim 12 further comprising the alternative step for said unemployed worker (UW) to obtain membership status with said ASO™ through an Authorized Company Subscriber (ACS) wherein said ACS is the current or most recent employer of said UW and said ACS has received authorization from said ASO™ to provide Career Management System (CMS) services in the specific industry and professional discipline of said UW, and for the execution of an agent/client agreement between said UW and said ACS for the entry and setup of said unemployed worker UW into said ASO™ database.

16. The method of claim 15 further comprising the step for establishing the basis for said ACS to receive full or split placement fee credit or other consideration upon direct-hire or contract placement of said UW with whom agent/client relationship has been established.

17. The method of claim 13 including means for said unemployed worker (UW) to terminate said agent/client relationship with said placement agent subscriber (PAS) and to select another PAS for establishment of new agent/client relationship, which best serves the needs of said UW.

18. The method of claim 15 including means for said unemployed worker (UW) to terminate said agent/client relationship with said ACS and to select a placement agent subscriber (PAS) for establishment of new agent/client relationship which best serves the needs of said UW.

19. The method of claim 1 including means for said placement agents (PA) to obtain certification from said ASO™ to provide full range of said ASO™ CMS service modules to unemployed workers (UW) which shall include CADG, JTR, ES, ER, TLO and resume and profile development, thereby establishing PAS status.

20. The method of claim 1 including means for said companies (CO) to obtain certification from said ASO™ to provide full range of said ASO™ CMS service modules to unemployed workers (UW) which shall include CADG, JTR, ES, ER, TLO and resume and profile development, thereby establishing ACS status.

21. The method of claim 1 including means for said governmental agencies (GA) to obtain authorization from said ASO™ as essential stakeholder for furtherance of said ASO™ CMS, and to gain access to said ASO™ database thereby entitling said governmental agency (GA) to all rights, benefits and privileges of an Authorized Governmental Agency (AGA).

22. The method of claim 1 including means for said unemployed workers UWs to increase awareness and gain access to a wider number and range of employment opportunities by establishing and maintaining the Global Employment Network.

23. The method of claim 22 including means to and to improve the speed and accuracy of matching the right candidates' skills and background with the right job opportunities with Universal Mapping technology.

24. The method of claim 1 including means to capture and maintain longitudinal work history, education, professional certifications and job skills data for tracking the long-term outcome of workers.
